(19) United States
(12) Patent Application Publication
(10) Pub. No.: US 2015/0240609 A1
(43) Pub. Date: Aug. 27, 2015

(54) MAGNETIC POLYMERS FOR IMPROVING HYDROCARBON RECOVERY OR DRILLING PERFORMANCE

(71) Applicant: BAKER HUGHES INCORPORATED, Houston, TX (US)

(72) Inventors: Gloria Santos Lucas, Rio de Janeiro (BR); Lirio Quintero, Houston, TX (US)

(73) Assignee: BAKER HUGHES INCORPORATED, Houston, TX (US)

(21) Appl. No.: 14/610,407

(22) Filed: Jan. 30, 2015

Related U.S. Application Data
(60) Provisional application No. 61/944,923, filed on Feb. 26, 2014.

(51) Int. Cl. E21B 43/16; C09K 8/62; C09K 8/58; C09K 8/02; E21B 43/26; E21B 21/00

(52) U.S. Cl. CPC E21B 43/16; E21B 43/26; E21B 21/003; C09K 8/58; C09K 8/02; C09K 8/62

(57) ABSTRACT

A wall of a subterranean reservoir wellbore may be at least partially coated with magnetic polymers. Alternatively, a downhole fluid having magnetic polymers may be circulated within the wellbore to at least partially coat the wall of the wellbore with the magnetic polymers. A magnetic field may be applied to the wall of the wellbore having the magnetic polymer coating for allowing the magnetic polymers to improve hydrocarbon recovery and/or drilling performance by a method, such as but not limited to preventing or inhibiting lost circulation, improving or increasing rate of penetration (ROP), reducing frictional pressure during wellbore construction, preventing or inhibiting corrosion, and combinations thereof.

### CROSS-REFERENCE TO RELATED APPLICATION

This application claims the benefit of Provisional Patent Application No. 61/944,923 filed Feb. 26, 2014, which is incorporated by reference herein in its entirety.

### TECHNICAL FIELD

The present invention relates to magnetic polymers and more particularly relates to methods of coating a wall of a subterranean reservoir wellbore for improving hydrocarbon recovery and/or drilling performance upon subsequent application of a magnetic field.

### BACKGROUND

When improving hydrocarbon recovery or drilling performance, there are several aspects to consider, such as reducing the non-productive time, increasing the life of the well, preventing formation damage, etc. Reducing the non-productive time may be accomplished by, but not limited to, increasing the ROP, reducing frictional pressure, and combinations thereof. Preventing or inhibiting corrosion of the well may reduce failure of downhole tools and/or extend the life of the well. Preventing or inhibiting lost circulation may prevent formation damage, as well as improve hydrocarbon recovery.

One of the primary concerns in upstream deepwater operations is the operational narrow window between pore pressure and fracture gradient that often results in major fluid losses during drilling, running, casing, and cementing processes. Thus, the lost circulation prevention and control are crucial to successful drilling and completion activities. Loss of circulation is one of the biggest contributors to drilling non-productive time, and is the most difficult segment of drilling in which to make economic decisions.

The loss of circulation is the phenomenon in which drilling fluid leaks away via fractures or openings in the wellbore and/or formation. This loss of fluid can be quantified according to its severity, including: seepage losses, partial losses, severe, and total or catastrophic losses. Each situation is specifically handled depending on the operational, personnel and economic risks involved, and the solutions applied. One of the main causes of loss of circulation includes exceeding the fracture gradient with excessive fluid weights or high surge pressures and equivalent circulating densities, which induces fractures in the formations and produces fluid losses while tripping pipe, breaking circulation, or raising fluid weights.

The rate of penetration (ROP) is the speed at which a drill bit breaks the rock/formation under it to deepen the borehole; increasing the ROP may reduce the non-productive time. Mechanical aspects of the drill bit may be altered to enhance the ROP, or chemicals may be added, e.g. to the drill bit, to alter the chemical composition of the formation. For example, ROP enhancers/enhancements may include, but are not necessarily limited to, surfactants and polymers, in a synthetic base oil carrier, such as a synthetic based olefin or ester.

Highly-permeable formations may include but are not limited to massive sands, pea gravel, shell beds, reef deposits, and combinations thereof, and may be indicated by continuous gradual seepage losses, and partial returns of downhole fluids. Highly-porous formations—sands, gravel beds, or reef deposits. This type of formation may be indicated by partial loss of return of a downhole fluid that may develop slowly and increase with penetration. Cavernous and vugular formations may include limestone, dolomite, chalk, and other formations with secondary porosity, which may be indicated by sudden and severe to complete loss of returns of downhole fluids that may be accompanied by sudden erratic rates of penetration.

The loss of circulation may vary from seepage (about 1 to about 10 bbl/h loss rate) to partial (about 10 to about 50 bbl/h loss rate) to severe (about 50 to about 100 bbl/h loss rate) to total losses (greater than about 500 bbl/h loss rate), and may culminate in extremely costly remedial treatments or catastrophic results. Depending on the severity of this process, the conventional lost circulation materials used to prevent lost circulation are not cost effective, primarily if the usage of huge volumes of them becomes necessary, and additionally if they don't guarantee the durable sealing of the lost zone.

Depending on the cause of loss of circulation, remedial procedures involve reducing the pressure exceeded by the circulating fluid, or filling the openings through which a downhole fluid is escaping. A slurry may be added that can become stiff on standing for filling the fractures or opening of the wellbore to prevent or inhibit lost circulation, or introducing a bridging or plugging solid so that normal filtration can occur.

The classification of the lost circulation materials may be, but is not limited to granular materials, flaky materials, fibrous materials, a slurry, and combinations thereof. The granular materials, may be ground nutshells, or vitrified, expanded shale particles, and the like. These materials have strength and rigidity and may seal by jamming these granular materials just inside the openings. The flaky materials may be, but are not limited to shredded cellophane, mica flakes, plastic laminates, wood chips, and the like. These materials are believed to lie flat across the face of the formation and thereby cover the openings. The fibrous materials may be, but are not limited to cotton fibers, bagasse, hog hair, shredded automobile tires, wood fibers, sawdust, paper pulp, and the like. These materials have relatively little rigidity, and tend to be forced into large openings. Slurries may be or include, but are not limited to hydraulic cement, diesel oil-bentonite-muds (DOB) mixes, high-filter-loss muds, and the like. The slurries tend to have a strength that increases over time after placement of the slurry.

A type of lost circulation material may include a polyacrylamide dispersion in water that is emulsified in paraffinic oil where bentonite is added into the external (oil) phase. Near the drill bit, where high shear rates are prevailing, the emulsion may be broken, and the bentonite is wetted by water and crosslinked with polyacrylamide, and resulting in a viscoelastic material in the formation. Crosslinked polymers have been used for severe lost circulation control, since they are not easily reversible.

A crosslinked polymer has a high apparent viscosity and strong cohesive force and may not be easily diluted by downhole fluids. The cross-linked polymer may be pumped normally, becoming viscoelastic in the “weak zone”. The cross-linked polymer has good chemical compatibility with various other components of lost circulation material. Inorganic bridge materials may be combined with cross-linked materials to enhance thermal stability and optimize particle size distribution. Free-chain movement may be prevented by cross-linking between chains of the polymer matrix. This, in turn, results in an increased strength, decreased flexibility, and increased brittleness of the polymer matrix. Physical crosslinking occurs when long chains entangle, effectively forming chemical “knots” between them. Crosslinking may be carried out by applying: heat, mechanical force, exposure to ionizing and nonionizing radiation (such as microwave), exposure to active chemical agents, or any combination of these. As the extent of crosslinking increases, there is a rapid increase in viscosity and the material becomes viscoelastic, at this point the system is “gelled”. Industrially important crosslinked polymers include: phenol and amino resins, alkyl resins, unsaturated polyesters, epoxy resins, concrete, silicon dioxide, carbon, siloxanes, isocyanates, acrylic copolymers, unsaturated and saturated hydrocarbons, halogen-containing hydrocarbons, ionomers, and combinations thereof.

Horizontal sections may be drilled with a drilling fluid containing a polymer, e.g. a viscosifier agent; sized calcium carbonate (CaCO₃), such as but not limited to bridging agents, calcium chloride (CaCl₂); or sodium chloride (NaCl); and additives (usually starch or another polymer) tailored to control loss of circulation. Field experience has demonstrated that mixtures, heterogeneous in shape, size, and strength, are usually more likely to form a seal than is a single material. The lost circulation material specifications frequently involve laboratory performance tests in addition to certain physical properties, such as screen size distribution and bulk density.

It would be desirable if methods were devised to improve hydrocarbon recovery and/or drilling performance by using materials that are easily synthesized to be readily available.

### SUMMARY

There is provided, in one form, a method for improving a property such as, but not limited to drilling performance, hydrocarbon recovery, and combinations thereof by applying a magnetic field to the wall of a subterranean reservoir wellbore where the wall has been at least partially coated with magnetic polymers. The magnetic field may allow the magnetic polymers to improve the property by a method, such as but not limited to preventing or inhibiting lost circulation, improving or increasing the rate of penetration (ROP), reducing frictional pressure during wellbore construction, preventing or inhibiting corrosion, and combinations thereof.

There is further provided in another non-limiting embodiment for preventing or inhibiting lost circulation of a downhole fluid. The downhole fluid may be circulated within a subterranean reservoir wellbore and at least partially coat the wall of the subterranean reservoir wellbore with the magnetic polymers. The downhole fluid may include magnetic polymers in an amount effective to prevent or inhibit lost circulation of the downhole fluid once the downhole fluid is circulated within the subterranean reservoir wellbore. A magnetic field may be applied to the magnetic polymers along the coated wall of the subterranean reservoir wellbore to allow the magnetic polymers to prevent or inhibit lost circulation of the downhole fluid.

There is provided, in another embodiment, a subterranean reservoir wellbore where the wellbore wall may have magnetic polymers disposed thereon. The magnetic polymers may include a magnetic particle, such as but not limited to iron, cobalt, nickel, magnesium, molybdenum, tantalum, alloys thereof, spinels thereof, oxides thereof, and combinations thereof. The magnetic polymers may have an average size less than about 1000 nm.

The magnetic polymers appear to help improve hydrocarbon recovery and/or drilling performance once a magnetic field is applied to the wellbore by allowing the magnetic polymers to provide a multitude of functionalities within the wellbore.

### DETAILED DESCRIPTION

It has been discovered that at least partially coating a wall of a wellbore with magnetic polymers may improve hydrocarbon recovery and/or drilling performance by a method, such as but not limited to preventing or inhibiting lost circulation, improving or increasing rate of penetration (ROP), reducing frictional pressure during wellbore construction, preventing or inhibiting corrosion, and combinations thereof.

Magnetic polymers may respond to externally applied stimuli, such as but not limited to electrical stimuli, stress/strain (including pressure) stimuli, magnetic stimuli, thermal stimuli, light, solvent composition, etc. Magnetic polymers may react to external stimuli to result in a defined engineering or scientific goal. Much of the strength of the magnetic polymer comes from the contact of the magnetic particle with the polymeric matrix. The polymeric matrix also allows the magnetic polymer to swell and gives the magnetic polymer elasticity.

Each magnetic polymer may have a magnetic particle embedded within a polymer matrix. The magnetic particle may be or include, but not limited to iron, cobalt, nickel, magnesium, molybdenum, tantalum, alloys thereof, spinels thereof, oxides thereof, and combinations thereof, as well as alloys and spinels. Among these magnetic particles, metal oxides may be more resistant to oxidation. The polymer matrix may be or include polystyrene (PS), polyacrylamide, dextran, poly(vinyl alcohol) (PVA), polymethylmethacrylate (PMMA); copolymers and/or triblock polymers, such as but not limited to polyisopropene-block-poly(2-cinnamoylethyl methacrylate)-block-poly(tert-butyl acrylate), copolymers of acetoacetoxyethyl methacrylate and N-vinylcaprolactam, copolymers of N-isopropyl acrylamide (NIPA) and glycidyl methacrylate.

Nanoparticles present single domain structures, which include groups of spins all pointing in the same direction and acting cooperatively. By contrast, microparticles exhibit multidomain structures consisting of many single domains, separated by walls that generate magnetic flux closures rendered to the material's non-magnetic behavior. Generally, nanoparticles have an average particles size of 999 nm or less where macroparticles are larger than 1 μm or larger.

The size of the magnetic particle distinguishes the magnetic polymers as one of two different types: superparamagnetics and ferromagnetics, and the dispersions formed from them are called ferrofluids (or magnetic fluids), and magnetorheologycal fluids, respectively. Ferrofluids (single domains) may be used to switch off the magnetic state after usage of the magnetic polymer, e.g. when it may be desirable for the magnetic particle to have a minimum disturbance on the process or when the surface-to-volume ratio needs to be large. On the other hand, magnetorheological fluids (multidomain structures) present applicability when yield stress has to be accurately controlled by changing the magnetization, or when it is desirable to have a strong response to the magnetization.

The size of the magnetic particle may determine the coercivity as well as remanence, or saturation remanent magnetization. Coercivity characterizes the reverse field strength needed to reduce the magnetization of a material to zero after achieving the saturation magnetization. Saturation remanent magnetization is the magnetization left behind from a permanent magnet after removing the magnetic stimulus. Thus, depending on the magnetic properties and the size of the magnetic particles, the applications of the magnetic particles embedded within the polymeric matrix may change.

Ferrofluids derived from iron oxides typically have magnetic nanoparticles within the size range from about 5 nm to about 15 nm with a large surface-to-volume ratio. The coercivity of the ferrofluids may be small, such as but not limited to a size near to zero, i.e. the fluid exhibits magnetic properties only in the presence of the magnetic field. Magnetorheological fluids though may have magnetic particles within a size range of about 20 nm to about 1000 nm with a small surface-to-volume ratio. The fluid may exhibit magnetic properties even in the absence of the magnetic field.

For purposes of improving hydrocarbon recovery or drilling performance, the size of the magnetic polymer may be from about 5 nm independently to about 1000 nm, or alternatively from about 40 nm independently to about 400 nm in another non-limiting embodiment. The magnetic particle within the magnetic polymer may range in size from about 5 nm independently to about 1000 nm, or from about 20 nm independently to about 300 nm in another non-limiting embodiment. The molecular weight (mw) of the magnetic polymer may range from about 10,000 g/mol independently to about 25,000 g/mol.

The magnetic polymers may be: (i) polymer core-magnetic shell beads, (ii) magnetic core-polymer shell beads, (iii) magnetic polymer beads with homogeneously dispersed magnetic particles, and combinations thereof. In one non-limiting instance, the magnetic polymers may be synthesized by in-situ formation of the magnetic particles into the polymer matrix, i.e. magnetic polymer beads may be prepared by co-precipitation of iron salts directly into a polymer matrix and subsequently controlling the nucleation and growth of the magnetic polymers. Examples of polymeric matrices that may be used to prepare magnetic beads by this method include, but are not limited to: polystyrene (PS), poly(styrenesulfonate) (PSS), poly(maleic acid) (PMA), poly(acrylic acid) (PAA), polyacrylamide (PAM), triblock polymer polyisopropene-block-poly(2-cinnamoylethyl methacrylate)-block-poly(tert-butyl acrylate), dextran, poly(vinyl alcohol) (PVA), copolymers of acetoacetoxyethyl methacrylate and N-vinylcaprolactam, copolymers of N-isopropyl acrylamide (NIPA), glycidyl methacrylate, polymethylmethacrylate (PMMA), poly(2-acrylamido-2-methylpropanesulfonate) (PAMPS), and combinations thereof. In another non-limiting embodiment, the polymerization may occur in-situ in the presence of magnetic particles. This allows for the preparation of porous magnetic beads, and a means for tailoring the chemical and interfacial properties of the polymer beads by incorporation of monomers with desired functional groups. Pickering emulsions, three-dimensional, and emulsion polymerization may be prepared this way.

Alternatively, a pre-formed polymer matrix may be mixed with magnetic particles. One example may include a polymer core-magnetic shell that may be prepared by disposing magnetic particles onto the surface of the polymer beads by adsorption or layer-by-layer (LBL) coating. Magnetic core-polymer shell beads may be prepared, in another example, by coating the magnetic particles with a polymer by adsorption or LBL technique. Magnetic particles may be homogenously dispersed in a polymer solution and emulsified as a disperse phase to obtain an emulsion. The magnetic polymers may also be prepared while under magnetization to obtain magnetic beads with tailor-made anisotropy. The magnetic polymers may also have chemicals encapsulated with the magnetic particles. The chemicals may be or include, but are not necessarily limited to corrosion inhibitors, drag reducers, fluid loss agents, scale inhibitors, asphaltene inhibitors, paraffin dispersants, and combinations thereof

In one non-limiting example, nanoparticles of Fe(O) may be dispersed into polymethyl methacrylate (PMMA) by emulsion polymerization techniques in a semicontinuous process to exhibit superparamagnetic behavior based on their small coercivity. A surfactant may be used during the polymerization to avoid aggregation of the magnetic particles. The concentration of surfactant may be maintained below the critical micellar concentration (cmc) in the pre-emulsion.

In another alternative embodiment, magnetic polymers may be synthesized having thin polystyrene (PS) cores and thicker Fe₃O₄ shell. Another crosslinked polymer gel/matrix may include polyvinylpyrrolidone, using peroxide (H₂O₂) as an oxidizing agent, by a simple two-step process. The magnetic composite synthesis was obtained by carbonizing the polymer gel at 400° C. for 1 hour. The composites were synthesized with different magnetic behavior according to the hydrothermal process conditions, mainly by varying the amount of oxidizing agent. They concluded that several synthesis parameters could significantly affect the magnetic polymer properties. The synthesis of magnetic polymers should be followed by precise physico-chemical characterizations.

Magnetic polymers may swell in solvents, particularly beads with gel-like structure, and the formation of additional crosslinking may occur due to the nanoparticle interaction with the polymer chains. The swelling of the magnetic polymers in a water or solvent medium may improve hydrocarbon recovery and/or drilling performance in terms of lost circulation by filling the cracks in the wellbore and/or the formation. The swelling in turn produces high pressure on the wall of the wellbore. The cross-linking between swollen beads may also increase the ability of the magnetic polymers to prevent or inhibit lost circulation. Some magnetic polymers may have a collapse of thermosensitive beads, which may be triggered by applying a magnetic field.

Different researchers have observed that the magnetic behavior of magnetic polymers may be significantly altered as a function of both particle characteristics (such as type, size, and concentration) and polymer structure obtained (encapsulating the magnetic particles). From a magnetic viewpoint, the polymer bead is a dilute ensemble of non-interacting magnetic moments. In one example, a ferrofluid saturation magnetizations (Ms) composed of 15 nm magnetite (Fe₃O₄) particles (without polymerization) had a higher magnetization than the magnetic polymers comprising the 15 nm magnetite. This reduction in the Ms of magnetic polymers was attributed to two possible factors: oxidation processes during the synthesis, and/or the presence of polymer on the surface of the particles.

Magnetic polymers may be designed to better control loss of hydrocarbon recovery during drilling operations. The wettability of the magnetic polymer can be changed as well as their magnetic properties, which allows the magnetic polymers to be used in water-based drilling muds, oil-based drilling muds, synthetic-based drilling muds, and combinations thereof.

To improve hydrocarbon recovery and/or drilling performance in a subterranean reservoir wellbore, a wall of the wellbore may have magnetic polymers thereon. In one non-limiting instance, a downhole fluid having magnetic polymers may be circulated within the wellbore to form at least a partial coating that includes magnetic polymers along the wall of the wellbore. The amount of magnetic polymers within the downhole fluid may range from about 0.01 wt % independently to about 5.0 wt %, or alternatively from about 0.01 wt % independently to about 1.0 wt %. In another non-limiting embodiment, a magnetic polymer coating may be applied to the wellbore wall prior to the insertion of the wellbore into the reservoir.

A magnetic field may be applied to the wellbore, or more specifically the wall of the wellbore having the magnetic polymer coating. The magnetic field may allow the magnetic polymers to improve hydrocarbon recovery and/or drilling performance from the wellbore by a method, such as but not limited to preventing or inhibiting lost circulation, improving or increasing rate of penetration (ROP), reducing frictional pressure during wellbore construction, preventing or inhibiting corrosion, and combinations thereof. Lost circulation may be prevented or inhibited where the magnetic field allows the magnetic polymers to swell within a crack of the wall/formation upon application of the magnetic field to the wellbore. ROP may be improved or increased by controlling the fluid rheological properties upon application of the magnetic field. The frictional pressure may be reduced during wellbore construction by adding magnetic polymers to the drilling fluid and/or the completion fluid with subsequent application of the magnetic field to the magnetic polymers.

Chemicals, such as but not limited to corrosion inhibitors, drag reducers, fluid loss agents, scale inhibitors, asphaltene inhibitors, paraffin dispersants, and combinations thereof may be encapsulated by the magnetic polymers. These chemicals may be delivered upon controlled release of the chemicals from the magnetic polymers within the desired place of the well. The magnetic polymers may be guided by a magnetic field where the magnetic field causes swelling of the magnetic polymer and release of the chemical. The corrosion inhibitors may prevent or inhibit corrosion at a desirable location of the wellbore. Prevent or inhibit is defined herein to mean that the lost circulation or corrosion may be suppressed or reduced. That is, it is not necessary for lost circulation or corrosion to be entirely prevented for the methods discussed herein to be considered effective, although complete prevention is a desirable goal.

The downhole fluids, which may include drilling fluids, completion fluids, production fluids, and servicing fluids, except as noted, may also include other typical additives for improving the performance of the downhole fluid. In another non-limiting embodiment, the downhole fluid may include additives to aid in better functionality of the magnetic polymers. Such additives may be or include, but are not limited to surfactants, salts, pH control additives, viscosifier additives, and combinations thereof.

Surfactants may be used to enhance the thermodynamic, physical, and rheological properties of magnetic polymers within the downhole fluids. These magnetic polymers may be dispersed in the downhole fluid, which may be a drilling fluid, a completion fluid, a production fluid, or a stimulation fluid. The downhole fluid may be a non-aqueous fluid or an aqueous fluid, or the downhole fluid may be a single-phase fluid, or a poly-phase fluid, such as an emulsion of oil-in-water (O/W) or water-in-oil (W/O). The magnetic polymers may be used in conventional operations and challenging operations that require stable fluids for high temperature and pressure conditions (HTHP).

It may be helpful in designing new fluids containing magnetic polymers to match the amount of the magnetic polymers with the proper surfactant/downhole fluid ratio to achieve the desired dispersion for the particular fluid. Surfactants are generally considered optional, but may be used to improve the quality of the dispersion of the magnetic polymers within the downhole fluid. Such surfactants may be present in the downhole fluids in amounts ranging from about 0.001 wt % independently to about 10 wt %, alternatively from about 0.01 wt % independently to about 5 wt %, where “independently” as used herein means that any lower threshold may be combined with any upper threshold to define an acceptable alternative range.

Expected suitable surfactants may include, but are not necessarily limited to non-ionic, anionic, cationic, amphoteric surfactants and zwitterionic surfactants, janus surfactants, and blends thereof. Suitable nonionic surfactants may include, but are not necessarily limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both. Suitable anionic surfactants may include alkali metal alkyl sulfates, alkyl ether sulfonates, alkyl sulfonates, alkyl aryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, and phosphate esters. Suitable cationic surfactants may include, but are not necessarily limited to, arginine methyl esters, alkanolamines and alkylenediamides. Suitable surfactants may also include surfactants containing a non-ionic spacer-arm central extension and an ionic or nonionic polar group. Other suitable surfactants may be dimeric or gemini surfactants, cleavable surfactants, janus surfactants and extended surfactants, also called extended chain surfactants.

In the foregoing specification, the invention has been described with reference to specific embodiments thereof, and has been described as effective in providing methods and structures for improving hydrocarbon recovery and/or drilling performance by a method, such as but not limited to preventing or inhibiting lost circulation, improving or increasing the rate of penetration (ROP), reducing frictional pressure during wellbore construction, preventing or inhibiting corrosion, and combinations thereof. However, it will be evident that various modifications and changes can be made thereto without departing from the broader spirit or scope of the invention as set forth in the appended claims. Accordingly, the specification is to be regarded in an illustrative rather than a restrictive sense. For example, specific downhole fluids, magnetic particles, polymeric components, and magnetic polymers falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the method may consist of or consist essentially of applying a magnetic field to the wall of a subterranean reservoir wellbore where the wall has been at least partially coated with magnetic polymers, and the magnetic field allows the magnetic polymers to improve hydrocarbon recovery and/or drilling performance by a method, such as but not limited to preventing or inhibiting lost circulation, improving or increasing rate of penetration (ROP), reducing frictional pressure during wellbore construction, preventing or inhibiting corrosion, and combinations thereof.

The words “comprising” and “comprises” as used throughout the claims, are to be interpreted to mean “including but not limited to” and “includes but not limited to”, respectively.

1. A method for improving a property selected from the group consisting of hydrocarbon recovery, drilling performance, and combinations thereof; wherein the method comprises:
applying a magnetic field to the wall of a subterranean reservoir wellbore, wherein the wall has been at least partially coated with magnetic polymers in an effective amount to improve the property, whereby the magnetic field allows the magnetic polymers to improve the property by a method selected from the group consisting of preventing or inhibiting lost circulation, improving rate of penetration (ROP), reducing frictional pressure during wellbore construction, preventing or inhibiting corrosion, and combinations thereof; wherein the magnetic polymers are selected from the group consisting of polymer core-magnetic shell beads, magnetic core-polymer shell beads, magnetic polymer beads with homogeneously dispersed magnetic particles, and combinations thereof.

2. The method of claim 1, further comprising at least partially coating the wall of the subterranean reservoir wellbore with magnetic polymers prior to applying a magnetic field to the wall of the subterranean reservoir wellbore.

3. The method of claim 1, further comprising circulating a downhole fluid having magnetic polymers within a subterranean reservoir wellbore prior to applying a magnetic field to the wall of the subterranean reservoir wellbore, wherein the downhole fluid comprises magnetic polymers in an amount effective to improve the property.

4. The method of claim 3, wherein the amount of magnetic polymers within the downhole fluid ranges from about 0.01 wt % to about 5.0 wt %.

5. The method of claim 3, wherein the downhole fluid is selected from the group consisting of a drilling fluid, a completion fluid, a production fluid, a fracturing fluid, and combinations thereof.

6. The method of claim 1, wherein the magnetic polymers improve the property as compared to an otherwise identical method absent the magnetic polymers.

7. The method of claim 1, wherein each magnetic polymer comprises a magnetic particle and a polymeric matrix.

8. The method of claim 1, wherein each magnetic polymer comprises a magnetic particle selected from the group consisting of iron, cobalt, nickel, magnesium, molybdenum, tantalum, alloys thereof, spinels thereof, oxides thereof, and combinations thereof.

9. The method of claim 1, wherein each magnetic polymer comprises at least one chemical selected from the group consisting of corrosion inhibitors, drag reducers, fluid loss agents, scale inhibitors, asphaltene inhibitors, paraffin dispersants, and combinations thereof.

10. The method of claim 1, wherein the magnetic polymers have an average size less than about 1000 nm.

11. A method for preventing or inhibiting lost circulation of a downhole fluid comprising:
circulating a downhole fluid within a subterranean reservoir wellbore, wherein the downhole fluid comprises magnetic polymers in an amount effective to prevent or inhibit lost circulation of the downhole fluid, and wherein the magnetic polymers at least partially coat the wall of the subterranean reservoir wellbore with the magnetic polymers as the downhole fluid is circulated; wherein the magnetic polymers are selected from the group consisting of polymer core-magnetic shell beads, magnetic core-polymer shell beads, magnetic polymer beads with homogeneously dispersed magnetic particles, and combinations thereof; and
applying a magnetic field to the at least partially coated wall of the subterranean reservoir wellbore whereby the applied magnetic field allows the magnetic polymers to prevent or inhibit lost circulation of the downhole fluid.

12. The method of claim 11, wherein the downhole fluid is selected from the group consisting of a drilling fluid, a completion fluid, a production fluid, a fracturing fluid, and combinations thereof.

13. The method of claim 11, wherein the at least partially coating the wall of the subterranean reservoir wellbore with the magnetic polymers prevents or inhibits the downhole fluid from being lost once the downhole fluid is circulated downhole by an increased amount as compared to an otherwise identical downhole fluid absent the magnetic polymers.

14. The method of claim 11, wherein the magnetic polymers comprise a magnetic particle selected from the group consisting of iron, cobalt, nickel, magnesium, molybdenum, tantalum, alloys thereof, spinels thereof, oxides thereof, and combinations thereof.

15. The method of claim 11, wherein each magnetic polymer comprises a magnetic particle and a polymeric matrix.

16. The method of claim 11, wherein the magnetic polymers are encapsulated with at least one chemical selected from the group consisting of corrosion inhibitors, drag reducers, fluid loss agents, scale inhibitors, asphaltene inhibitors, paraffin dispersants, and combinations thereof.

17. The method of claim 11, wherein the amount of magnetic polymers within the downhole fluid ranges from about 0.01 wt % to about 5.0 wt %.

18. The method of claim 11, wherein the magnetic polymers have an average size less than about 1000 nm.

19. A subterranean reservoir wellbore comprising a wall with magnetic polymers disposed thereon, wherein each magnetic polymer comprises a magnetic particle selected from the group consisting of iron, cobalt, nickel, magnesium, molybdenum, tantalum, alloys thereof, spinels thereof, oxides thereof, and combinations thereof, and wherein the magnetic polymers have an average size less than about 1000 nm; wherein the magnetic polymers are selected from the group consisting of polymer core-magnetic shell beads, magnetic core-polymer shell beads, magnetic polymer beads with homogeneously dispersed magnetic particles, and combinations thereof.
